(19) United States
(12) Patent Application Publication
(10) Pub. No.: US 2016/0244348 A1
(43) Pub. Date: Aug. 25, 2016

(54) A METHOD FOR TREATING ALKALINE BRINES

(71) Applicant: CRS INDUSTRIAL WATER TREATMENT SYSTEMS PTY LTD, Castle Hill, New South Wales (AU)

(72) Inventors: Aharon ARAKEL, Castle Hill, New South Wales (AU); Grant MOLONEY, Castle Hill, New South Wales (AU); Michael STARK, Castle Hill, New South Wales (AU); Samantha THEOBALD, Castle Hill, New South Wales (AU)

(73) Assignee: CRS INDUSTRIAL WATER TREATMENT SYSTEMS PTY LTD, Castle Hill, New South Wales (AU)

(21) Appl. No.: 15/032,254

(22) PCT Filed: Oct. 28, 2014
(86) PCT No.: PCT/AU2014/050319

§ 371 Date: Apr. 26, 2016

(30) Foreign Application Priority Data
Oct. 28, 2013 (AU) 2013904160
Aug. 8, 2014 (AU) 2014903094

(51) Int. Cl. C02F 9/00; C22B 3/44; C01F 11/18; C02F 1/04; C02F 1/52; C02F 1/66; C02F 5/06; C02F 5/02; C22B 26/10; C01F 5/24

(52) U.S. Cl. CPC C02F 9/00; C22B 26/10; C22B 3/44; C01F 11/18; C01F 5/24; C02F 1/5236; C02F 1/66; C02F 5/06; C02F 5/02; C02F 1/04; C02F 2209/06; C02F 2303/22

(57) ABSTRACT

Disclosed herein is a method for treating an alkaline brine. The method comprises adding a source of magnesium ions to the alkaline brine. A resultant magnesium-containing precipitate is separated to produce a spent brine. If the spent brine contains a sufficient amount of carbonate or bicarbonate ions, the spent brine is processed to recover a carbonate product.

### TECHNICAL FIELD

The present invention relates to methods for treating alkaline brines and, in particular, alkaline brine effluents.

### BACKGROUND ART

Many industries, including the mining/mineral processing, food processing, coal mining, coal seam gas production and coal power generation industries, generate alkaline brine effluents, which can be a major operational and environmental problem. Indeed, cost-effective effluent management is often a key issue faced by these industries. The problem can be exacerbated where the generation of large volumes of such effluents limits the scope and availability of conventional disposal options such as storage and evaporation or deep-well injection.

The treatment of many alkaline brines can also be problematic because they contain relatively high concentrations of dissolved bicarbonate and carbonate ions, which can cause scaling in equipment. They may also often contain other contaminants, which can also cause scaling in equipment, as well as other problems such as fouling of membranes used in the treatment process. Consequentially, the applicability of conventional processing methods for treating alkaline brines is often limited and relatively costly.

### SUMMARY OF INVENTION

The present invention provides a method for treating an alkaline brine. The method comprises adding a source of magnesium ions to the alkaline brine. A resultant magnesium-containing precipitate is separated to produce a spent brine. If the spent brine contains a sufficient amount of carbonate or bicarbonate ions, the spent brine is processed to recover a carbonate product.

In some embodiments, reactions between the source of magnesium ions and the alkaline brine may be controlled to favour the formation of a precipitate comprising mainly magnesium carbonate (MgCO₃). The precipitate can subsequently be collected, purified if necessary, and reused or sold in order to offset the overall cost of the treatment method.

In some embodiments, the alkaline brine may contain relatively high amounts of undesirable dissolved species such as silica, heavy metals, sulphate, phosphate, fluoride, bromide and iodide. Such species have a tendency to precipitate or crystallise and cause problems such as fouling of membranes or contaminating equipment (e.g. by causing scaling, which can reduce the operational efficiency of the equipment). Such species may also contaminate what might otherwise be a useful solid or liquid product obtainable from the alkaline brine. In such embodiments, it may be advantageous to control the reactions between the source of magnesium ions and the alkaline brine to favour the formation of a precipitate comprising mainly magnesium hydroxide (Mg(OH)₂). Magnesium hydroxide precipitate forms as a large gelatinous floc that has excellent flocculating and coagulating properties, and which, via a combination of crystallisation, flocculation, adsorption and coagulation, can trap many of the potential contaminants which are present in the alkaline brine as it settles. Separating the precipitate from the liquid (e.g. by filtration, settling or decantation) effectively removes both the magnesium hydroxide and the entrapped contaminants from the resultant spent brine. The inventors have found that a high proportion of contaminants such as silica etc. (which can cause significant downstream problems) in the alkaline brine are effectively adsorbed onto the surface of the magnesium hydroxide floes and can be removed with the magnesium hydroxide precipitate. Once the magnesium hydroxide precipitate is separated, a spent brine is produced, having a reduced contaminant content, but still containing a majority of the carbonate or bicarbonate ions originally present in the alkaline brine (a small proportion of the ions may be caught up in the magnesium hydroxide precipitate) for subsequent beneficial use. It should be noted that magnesium carbonate precipitates can also entrap contaminants, but to a much lesser extent than can magnesium hydroxide precipitates.

The composition of the magnesium-containing precipitate may be controlled using any one or a combination of the following: by controlling a pH at which the source of magnesium ions are added to the alkaline brine, by selecting the source of magnesium ions added to the alkaline brine, by selecting the amount of the source of magnesium ions added to the alkaline brine, by controlling the reaction duration, by controlling the mixing rate and by controlling a temperature of the alkaline brine.

In some embodiments, the spent brine may contain no (or, more likely, very few) carbonate or bicarbonate ions (as will be appreciated, the relative proportions of the carbonate/bicarbonate ions in the spent brine will depend on its pH) and the alkaline brine is considered to be treated. In some embodiments, however, the spent brine may contain an amount of carbonate or bicarbonate ions sufficient to justify further treatment that results in the production of a carbonate product. Such a carbonate product may itself be a vendible product, or the spent brine may be improved by removing the carbonate product.

In some embodiments, the spent brine may be processed to recover a carbonate product by adding a source of a divalent cation to the spent brine. The amount of the divalent cation added may, for example, be the amount required to cause precipitation of substantially all of the carbonate (and bicarbonate, if pH is managed appropriately) ions in the spent brine. The precipitate can subsequently be separated (e.g. by filtration, settling or decantation) for beneficial re-use, after which the primary components remaining in the treated spent brine will, at least in preferred embodiments, be sodium ions and chloride ions (as will be appreciated, in practice, the treated spent brine will rarely contain solely sodium ions and chloride ions, but will likely contain relatively low amounts of other species). Such a treated brine is known in the art as a “weighed brine” which, in the context of the present invention, is a purified brine suitable for downstream use (e.g. crystallisation of NaCl) and/or safe disposal (e.g. by means of deep-well injection). The composition of a weighed brine will depend to some extent on the nature of its downstream use. For example, a weighed brine intended for deep well injection may contain some carbonate and bicarbonate ions. However, a weighed brine intended to be used to obtain NaCl via crystallisation would need to be substantially free of carbonate and bicarbonate ions.

In alternate embodiments, the spent brine may be processed to recover a carbonate product (e.g. soda ash, Na₂CO₃) by evaporating the spent brine (e.g. by heating and evaporating the spent brine).

Advantageously, the method of the present invention can be used to treat alkaline brines having practically any composition, and typically results in the production of a smaller amount of solid waste that requires disposal in a landfill (compared to prior art processes), if any waste is produced at all. Typically, a majority of the carbonate and bicarbonate ions present in the alkaline brine are used to form solid products during treatment, so they are not able to form salts that can cause scaling of downstream equipment. A beneficial product or products may also be obtained in the method of the present invention. The nature of the beneficial product(s) depends on the composition of the alkaline brine but, as all alkaline brines in accordance with the present invention contain a relatively high proportion of carbonate ions, at least some of the beneficial products will be carbonate-containing species, some of which may be vendible. Furthermore, even if the alkaline brine contains contaminants of the like discussed above, such contaminants can be removed in the method of the present invention without necessarily requiring the use of flocculants or additional reagents.

As will be appreciated, embodiments of the methods of the present invention may provide a zero liquid discharge (ZLD) treatment process where either all liquid is removed, or where any remaining liquid can be beneficially used (e.g. as a caustic liquid or a weighed brine suitable for downstream use).

### BRIEF DESCRIPTION OF DRAWINGS

Specific embodiments of the present invention will be described below, by way of example only, with reference to the following drawings, in which:

FIG. 1 shows a flowchart depicting methods (A) and (B) in accordance with general embodiments of the present invention:

FIG. 2(A) shows a flowchart depicting methods in accordance with alternate embodiments of the present invention;

FIG. 2(B) shows a flowchart depicting methods in accordance with alternate embodiments of the present invention;

FIG. 3 shows a flowchart depicting methods in accordance with alternate embodiments of the present invention; and

FIG. 4 shows a flowchart depicting methods in accordance with alternate embodiments of the present invention.

### DESCRIPTION OF EMBODIMENTS

The present invention relates generally to the treatment of saline-alkaline impaired water. In some embodiments, the invention relates to an integrated system for comprehensive treatment of alkaline brines, for the purpose of waste minimisation and cost optimisation through the recovery of useful products, and where possible the production of“weighed brine”.

The present invention provides a method for treating an alkaline brine. The method comprises adding a source of magnesium ions to the alkaline brine. A resultant magnesium-containing precipitate is then separated to produce a spent brine. If the spent brine contains a sufficient amount of carbonate or bicarbonate ions, the spent brine is processed to recover a carbonate product.

As used herein, the term “alkaline brine” is to be understood to mean a brine having an alkaline pH and which contains significant amounts of bicarbonate (HCO₃⁻) and carbonate (CO₃²⁻) ions, with their relative proportions depending on the pH of the alkaline brine and the source of the alkaline brine (naturally occurring alkaline brines tend to contain primarily bicarbonate ions, whilst industrial alkaline brines tend to contain significant amounts of carbonate ions). The concentrations of bicarbonate (HCO₃⁻) and carbonate (CO₃²⁻) ions are elevated compared to non-alkaline brines (e.g. other saline-impaired waters), and it is within the ability of a person skilled in the art to ascertain using routine measurements whether a particular brine is an alkaline brine suitable for treatment in accordance with the present invention. For example, the typical alkalinity and total dissolved solids of some specific alkaline brines are listed in the following Table 1.

TABLE 1
typical alkalinity and total dissolved solids of specific alkaline brines

| | Typical Alkalinity | |
|---|---|---|
| Brine Type | (mg/L CaCO₃) | Typical TDS (g/L) |
| Co-produced water from coal | 500-11,000 | 1-14 |
| seam gas fields | | |
| Brine from RO treatment of | 4,000-50,000 | 11-50 |
| coal seam gas co-produced | | |
| water | | |
| Brine from thermal | 40,000-200,000 | 60-300 |
| evaporation of coal seam gas | | |
| co-produced water | | |

The present invention may be used to treat any alkaline brine. Alkaline brine may, for example, be produced by natural processes such as geological weathering, or as a by-product of industrial processes such as mining/mineral processing, food processing, coal mining, coal seam gas production and coal power generation.

The alkaline brine used in the method of the present invention may be used as received (e.g. from the relevant source or industrial process), or pre-concentrated before the source of magnesium ions is added (e.g. by evaporation (e.g. solar or thermal), membrane distillation, reverse osmosis, forward osmosis, etc.).

Alkaline brines treated in accordance with the present invention are typically suitable for disposal using conventional techniques. The method of the present invention may result in one or more beneficial products being obtained. In some embodiments, the method of the present invention may result in ZLD. In some embodiments, the method of the present invention may result in the production of a weighed brine.

In the method of the present invention, a source of magnesium ions is added to the alkaline brine, which results in the formation of a magnesium-containing precipitate. In some embodiments, reactions between the introduced magnesium ions and components of the alkaline brine may be controlled to favour the formation of a precipitate comprising mainly magnesium carbonate (MgCO₃), which is a vendible product. Alternatively, reactions between the magnesium ions and components of the alkaline brine may be controlled to favour the formation of a precipitate comprising mainly magnesium hydroxide (Mg(OH)₂), which can be used to remove contaminates (as discussed above). As will be appreciated, a precipitate comprising “mainly” magnesium carbonate or magnesium hydroxide does not preclude the presence of other compounds in the precipitate (indeed, the incorporation of other compounds into the matrix of the magnesium hydroxide precipitate is desirable), but means that the relevant precipitate forms the bulk of the precipitate. For example, other precipitates which may form (to a much lesser extent) include a mixed MgCO₃ and Mg(OH)₂ precipitate, e.g. hydromagnesite (Mg₅(CO₃)₄(OH)₂.4H₂O, a mixed CaCO₃ and Mg(OH)₂ precipitate, or northupite (Na₃Mg(CO₃)₂Cl). It will be appreciated that other precipitants may be formed, depending on the composition of the alkaline brine.

Advantageously, using magnesium ions in the method of the present invention can provide a number of advantages over existing methods for treating industrial wastewaters. For example, depending on the content of the alkaline brine, the treatment process can be performed using as little as one step, with contaminants being capable of being removed and beneficial products obtained using the same reagent. As would be appreciated, multi-step treatments require additional process vessels (e.g. reactor, separator, storage tanks, pumps, etc.) and, wherever possible, it is desirable to minimise the number of steps (whilst still obtaining a treated alkaline brine, of course). Further, many sources of magnesium ions which can be used in the present invention are readily available and relatively cheap, thereby lowering the costs of the treatment process and reducing the risk of treatment costs fluctuating based on the current market price of specialised reagents.

Any standard technique (or combination of such techniques) known to those skilled in the art may be used to control or influence the composition of the magnesium-containing precipitate. Some of these techniques are discussed below.

In some embodiments, the composition of the magnesium-containing precipitate may be controlled by controlling the pH at which the magnesium ions are added to the alkaline brine (i.e. by controlling the pH of the reaction solution). As will be appreciated, pH will affect the relative proportions of the bicarbonate (HCO₃⁻) and carbonate (CO₃²⁻) ions in the alkaline brine. As the bicarbonate and carbonate salts of many metal ions have different solubilities, adjusting the pH can favour the formation of more insoluble precipitates.

Whether magnesium hydroxide or magnesium carbonate is formed is based largely on the pH of the solution. The main reactions governing which products are formed are:

Mg²⁺+2OH⁻ [symbol] Mg(OH)₂_{₍ₛ₎} (1)

Mg²⁺+CO₃²⁻ [symbol] +MgCO₃_{₍ₛ₎} (2)

OH⁻+HCO₃⁻ [symbol] CO₃²⁻+H₂O (3)

Reactions 1 and 2 are the precipitation reactions that create either the magnesium hydroxide or the magnesium carbonate, respectively. The determination of which solid is produced is based on the availability of hydroxide ions balanced against the availability of carbonate ions. The solubility products for magnesium hydroxide and magnesium carbonate are shown in equations 4 and 5 below.

Kₛₚ=[Mg²⁺]×[OH⁻]²=5.61×10⁻¹² (4)

Kₛₚ=[Mg²⁺]×[CO₃²⁻]=6.82×10⁻⁶ (5)

Combination of equations 4 and 5 yields the equilibrium condition where the produced solid is equally likely to be magnesium hydroxide and magnesium carbonate (although in reality a mixed salt will be formed):

$$\frac{{[ {OH}^{-} ]}^{2}}{[ {CO}_{3}^{2 -} ]} = 8.23 \times {10}^{- 7} \qquad ( 6 )$$

If the ratio of hydroxide ions to carbonate ions is in excess of that provided in equation 6, then formation of magnesium hydroxide would be favoured. If the ratio of hydroxide ions to carbonate ions is below that provided in equation 6, then formation of magnesium carbonate would be favoured. This ratio can be manipulated in the method of the present invention to favour the formation of either mainly magnesium hydroxide or magnesium carbonate precipitates.

Controlling the pH may also affect the salt produced and their solubility (e.g. Ca(HCO₃)₂ is much more soluble than CaCO₃), leading to more of the less soluble salt being precipitated.

In some embodiments, the composition of the magnesium-containing precipitate may be controlled by selecting the source of magnesium ions added to the alkaline brine. As will be appreciated, certain magnesium compounds will behave differently to others when exposed to the alkaline brine, and the choice of magnesium compound may influence the availability of magnesium ions for reaction.

The source of the magnesium ions added to the alkaline brine may be any magnesium containing species (e.g. compound or salt) which can provide magnesium ions in solution. For example, the source of magnesium ions may be selected from the group consisting of: magnesia (MgO), hydrated magnesia (Mg(OH)₂), dolime (MgO.CaO), hydrated dolime (Ca(OH)₂.Mg(OH)₂), magnesium chloride (MgCl₂), magnesium sulphate (MgSO₄), partially calcined dolomite, magnesium rich lime, seawater bitterns and mixtures thereof.

In some embodiments, the composition of the magnesium-containing precipitate may be controlled by selecting an amount of the source of magnesium ions added to the alkaline brine. For example, adding 100% of the magnesium required stoichiometrically instead of 20% may affect the product(s) obtained.

In some embodiments, the composition of the magnesium-containing precipitate may be controlled by controlling physical factors, such as one or more of: the physical form in which the source of magnesium ions is added; the temperature of the alkaline brine (or the temperature of reaction), the reaction duration and the mixing rate.

The source of magnesium ions may be added to the alkaline brine using conventional techniques. For example, the source of the magnesium ions may be added to a vessel containing the alkaline brine in powder form with vigorous stirring. Alternatively, the source of the magnesium ions may be added to a liquid, and the resultant solution or slurry mixed into the alkaline brine. Alternatively, liquid reagents such as seawater bitterns etc. may simply be poured into and mixed with the alkaline brine.

In some embodiments, the inventors have found that dry addition of the source of the magnesium ions resulted in the removal of more contaminants (and carbonate/bicarbonate species) than was the case for other forms of the source of the magnesium ions. Without wishing to be bound by theory, the inventors postulate that this is likely because the contaminants can also become adsorbed on the precipitate during the hydration process, which results in the formation of the magnesium hydroxide. Entrapment and removal is more integrated and results in greater removal efficiencies.

In some embodiments, the source of magnesium ions is added to the alkaline brine in combination with another reagent. Such a combination of reagents may enable specific useful products to be obtained, or cause the precipitate to form more rapidly or more completely. In some embodiments, the other reagent is a source of calcium ions. In some embodiments, the other reagent is selected from the group consisting of: lime (CaO), calcium chloride (CaCl₂), gypsum (CaSO₄.2H₂O), partially dehydrated gypsum (CaSO₄.nH₂O, where n=0.5 (for bassanite) or 0 (for anhydrate)) and mixtures thereof.

In specific embodiments, when solid product quality is not crucial, adding reagents in combination may also provide a simpler process which combines the carbonate, bicarbonate and other contaminant (e.g. silica) removal steps into one. Further, addition of CaO in addition to the source of magnesium ions can cause the pH to raise higher than otherwise possible utilising just MgO.

Once formed, the magnesium-containing precipitate can be separated from the liquid using techniques well known in the art. For example, a supernatant liquid may be carefully decanted once the precipitate has settled (e.g. in a settling tank). Alternatively (or in addition), the precipitate could be filtered from the liquid. Separating the magnesium-containing precipitate results in the production of a spent brine.

In some embodiments, the magnesium-containing precipitate may be a beneficial product, for example magnesium carbonate. In such embodiments, the magnesium-containing precipitate would typically contain none (or only a relatively small amount) of the contaminants such as silica discussed above. However, even when the magnesium-containing precipitate does contain such contaminants, these are likely to form only a very small proportion of the magnesium-containing precipitate, such that the precipitate's overall purity may be acceptable for its beneficial reuse (the same quantity of contaminant in the alkaline brine may, however, be capable of causing significant issues downstream). In embodiments in which the alkaline brine contains relatively high levels of these contaminants, however, it would typically be necessary to dispose of the magnesium-containing precipitate into which these contaminants had been incorporated. In such embodiments, however, the volume of such waste material can be kept to an absolute minimum.

In the method of the present invention, if the spent brine contains a sufficient amount of carbonate or bicarbonate ions, the spent brine is processed to recover a carbonate product.

As will be appreciated, the spent brine will almost always contain at least some carbonate or bicarbonate ions, with their relative proportions depending mainly on the pH of the spent brine. However, if the amount of these ions in the spent brine is relatively low, then a person skilled in the art would appreciate that further processing of the spent brine is neither necessary nor feasible (especially in a cost-effective manner). Whether an amount of carbonate or bicarbonate ions in a given spent brine is sufficient to warrant processing to recover a carbonate product will depend on factors such as the purpose of the treatment method (i.e. what is the intended end use of the treated alkaline brine?), composition of the spent brine (i.e. what, if any, useful carbonate product may be obtained from the alkaline or spent brine?) and a cost-benefit analysis. As two of the primary purposes of the present invention are to extract as much useful product as possible from the alkaline brine and to minimise waste, it is envisaged that further processing will be performed if a commercially viable amount of a carbonate product or carbonate/bicarbonate free liquid stream is obtainable. However, in some embodiments, depending on its intended use, the alkaline brine treated in accordance with the method of the present invention may not need to be completely free of carbonate or bicarbonate ions (e.g. it might not matter that products obtained from the method contain carbonate or bicarbonate impurities or, as noted above, treated alkaline brines intended for deep well injection may contain some carbonate species). Based on these factors, it is within the ability of a person skilled in the art to determine whether a particular amount of carbonate or bicarbonate ions in a particular spent brine justifies further treatment to produce the carbonate product.

In one extreme, for example, the spent brine may contain substantially no carbonate or bicarbonate ions (e.g. the magnesium-containing precipitate is MgCO₃, a stoichiometric amount of magnesium ions were added to the alkaline brine and the pH was relatively high so that carbonate ions were predominant, but not so high that the production of magnesium hydroxide was favoured), in which case the spent brine may not need any further processing. In another extreme, the bulk of the carbonate or bicarbonate ions originally present in the alkaline brine may remain in the spent brine, in which case the spent brine is processed to utilise at least a portion of those ions to recover a carbonate product (typically one which can be used to offset the cost of the treatment method). Typically, however, the amount of the carbonate or bicarbonate ions in the spent brine will lie between these extremes and, if so, it is within the ability of a person skilled in the art to determine whether any given amount of the carbonate or bicarbonate ions in the spent brine (or a proportion of the carbonate or bicarbonate ions in the spent brine compared to that in the alkaline brine) is sufficient to warrant further processing of the spent brine, based on the factors discussed above.

In some embodiments, for example, the spent brine will be processed to recover a carbonate product unless the spent brine contains less than about 5%, 7%, 10%, 12%, 15%, 17% or 20% of the amount of carbonate or bicarbonate ions originally present in the alkaline brine. In some embodiments, for example, the spent brine will be processed to recover a carbonate product unless the spent brine contains less than about 500 ppm, 700 ppm, 1,000 ppm, 1,500 ppm, 1,700 ppm or 2,000 ppm of carbonate and bicarbonate ions.

Any technique for determining whether the spent brine contains sufficient amounts of carbonate or bicarbonate ions to warrant further processing to recover a carbonate product may be used. For example, in some embodiments, determining whether the spent brine contains a sufficient amount of a carbonate or bicarbonate ions may involve measuring an amount of carbonate or bicarbonate ions in the feed alkaline brine (i.e. before the source of magnesium ions is added) and calculating the proportion of the carbonate or bicarbonate ions contained in the magnesium-containing precipitate. The amount of carbonate or bicarbonate ions in the spent brine will be the difference between these two values. Alternatively (or in addition), the amount of carbonate or bicarbonate ions in the spent brine can be directly measured in the spent brine using any suitable technique. Suitable techniques include laboratory based techniques for measuring carbonate and bicarbonate via titration with acid, or online techniques using instruments such as a Hach APA6000 or Teledyne 6800. In some embodiments, it may be necessary to perform such measurements at regular intervals (e.g. if the composition of the feed alkaline brine is continuously changing). In other embodiments, however, such accuracy may not be required, and measurements can be taken at less regular intervals.

In embodiments where the spent brine contains only a small or residual amount of carbonate or bicarbonate ions, further processing may not be necessary, feasible or economically viable. As substantially all or enough (depending on the end use) of the carbonate or bicarbonate ions originally present in the feed alkaline brine have been precipitated in earlier steps (e.g. with the magnesium-containing precipitate), the dominant species remaining in the treated brine would typically be sodium and chloride ions (although this will, of course, depend on the composition of the alkaline brine and the reagents utilised). In such circumstances, the weighed brine can be disposed using conventional techniques or its liquid evaporated to obtain sodium chloride salt. In embodiments where the treated brine contains components other than sodium and chloride ions, it may be necessary to further process the treated brine, using techniques known in the art specific to the relevant components.

The carbonate product may be any product containing a carbonate moiety, and is typically a solid product. Typically, the carbonate product is capable of beneficial re-use, thereby offsetting the overall cost of the treatment method. Whilst the spent brine typically includes both carbonate and bicarbonate ions (with their relative proportions depending mainly on the pH of the spent brine), the carbonate product will not contain a significant amount of bicarbonate moieties. As will be appreciated, many bicarbonate products (especially solid products) are not particularly stable and, even if they were to form, would decompose to the corresponding carbonate product relatively quickly. In addition, provided the pH of the spent brine was sufficiently high, removal of carbonate ions from the spent brine (i.e. during formation of the carbonate product) would result in bicarbonate ions converting to carbonate ions, which are then available to form more of the carbonate product.

In some embodiments, processing the spent brine to recover the carbonate product may consume substantially all of the carbonate and bicarbonate ions originally present in the spent brine. In alternate embodiments, processing the spent brine to recover the carbonate product may consume only a portion of the carbonate or bicarbonate ions remaining in the spent brine, with the resultant treated spent brine still containing some carbonate or bicarbonate ions (with their relative proportions depending mainly on the pH of the spent brine). Depending on the factors discussed above, the resultant treated spent brine may be further processed (e.g. in a subsequent processing step or steps) to recover additional useful products (including, but not limited to, additional carbonate products. However, as noted above, purification for industrial purposes needs only to satisfy the end outcome, and treated alkaline brines intended for downstream uses such as deep well injection are allowed to contain reasonably high levels of carbonate species. In such circumstances, it may not be cost-effective to remove all of the remaining carbonate or bicarbonate ions.

The carbonate product may be recovered using any suitable technique. For example, in embodiments where the spent brine contains more than what is deemed to be a sufficient amount of carbonate or bicarbonate ions, a second precipitation step (and subsequent recovery) may be used to recover the carbonate product. The second precipitation step may result in substantially all of the carbonate or bicarbonate ions remaining in the spent brine being recovered. Alternatively, only a proportion of the remaining carbonate or bicarbonate ions in the spent brine may be recovered in the second precipitation step, with a third (and subsequent) precipitation step(s) (or an evaporation step) being used to recover more (e.g. substantially all) of the carbonate or bicarbonate ions.

In some embodiments, processing the spent brine to recover a carbonate product comprises adding a source of a divalent cation to the spent brine. In some embodiments, the amount of the divalent cation added is the amount required to cause precipitation of substantially all of the carbonate ions (and bicarbonate ions if the resultant bicarbonate precipitate decomposes to the corresponding carbonate) in the spent brine. However, this need not always be the case and, in some embodiments, the amount of the divalent cation added may be the amount required to cause precipitation of only a portion of the carbonate or bicarbonate ions in the spent brine.

As would be appreciated, “substantially all”, in the context of precipitating substantially all of the carbonate or bicarbonate ions in the spent brine, does not preclude a small proportion of the carbonate or bicarbonate ions remaining in the spent brine and not forming part of the resultant carbonate product.

Any source of divalent cation may be used to cause precipitation of the carbonate product, provided that it forms a precipitate with the carbonate ions (or bicarbonate ions if the resultant bicarbonate precipitate decomposes to the corresponding carbonate) in the spent brine. The source of a divalent cation may be a chloride salt because the added chloride anions would not contaminate a weighed brine. The source of the divalent cation may be an alkaline earth chloride salt because the carbonates of the alkaline earth cations are all very insoluble.

The source of the divalent cation may, for example, be selected from the group consisting of: magnesium chloride (MgCl₂), calcium chloride (CaCl₂), magnesium sulphate (MgSO₄), calcium sulphate (CaSO₄), lime (CaO), dolime (MgO.CaO) and mixtures thereof. The source of the divalent cation may, for example, be added to the spent brine in either liquid, solid (e.g. powder) or slurry form.

In some embodiments, it may be advantageous to reduce the pH of the spent brine before processing to recover the carbonate product (e.g. by adding the source of the divalent cation). For example, reducing the pH to between about 8 and 10 can favour carbonate ions over bicarbonate ions whilst reducing the likelihood of magnesium hydroxide forming, especially if an excess of the source of magnesium was added in the earlier step for additional recovery of carbonate products. This will target the resulting solid to the desired species (MgCO₃) instead of other, lower value, minerals containing both carbonate and hydroxide groups such as hydromagnesite (Mg₅(CO₃)₄(OH)₂O.4H₂O). The pH of the spent brine may be reduced using any suitable substance, for example, by adding some of the feed alkaline brine (which typically has a pH of about 8) to the spent brine. Using the feed alkaline brine to reduce the pH of the spent brine would typically not be an option in situations where the feed alkaline brine contains the contaminants discussed above. In such embodiments, an alternate substance for reducing the pH of the spent brine would need to be used.

In some embodiments, it may be advantageous to reduce a volume of the spent brine (e.g. by thermal means) before processing to recover the carbonate product (e.g. by adding the source of the divalent cation). A smaller volume may be advantageous because it is easier and more cost efficient to process, and requires lower capital and power requirements. Reducing the volume may also affect the proportions of carbonate/bicarbonate ions in the spent brine.

In some embodiments, the method further comprises separating the carbonate product from a second spent brine. Any conventional technique may be used to perform this separation. The second spent brine may either be disposed or subsequently processed to recover additional useful products. For example, the second spent brine may be processed to produce sodium chloride (e.g. by evaporating the liquid).

The spent brine may be processed to recover the carbonate product in other ways. For example, in embodiments where the spent brine contains a sufficient amount of carbonate and bicarbonate ions, the spent brine may be processed to recover a carbonate product by evaporation. The composition of the resultant crystalized product would obviously depend on the components in the spent brine, but this technique could be used to produce beneficial carbonate products such as soda ash (Na₂CO₃) (possibly along with sodium bicarbonate (NaHCO₃), which does not typically decompose).

As discussed herein, the method of the present invention may result in the production of a vendible product or vendible products (in addition to the reduction or removal of carbonate/bicarbonate species from the alkaline brine). The sale or re-use of such vendible products may help to offset the costs associated with treating the alkaline brine. For example, embodiments of the present invention may produce the following vendible substances:

Magnesium Carbonate
Used in the pharmaceutical industry in antacid preparation and also in some laxatives
Employed as an anti-caking and colour retaining agent within the food industry
Used as a clarifying agent in the food and beverage industries
Used in the manufacture of inks, paints, plastics, rubbers, glass, ceramics
Magnesium source for animal feed/fed blocks
Magnesium source in fertilisers
As a filler, blocking and whitening agent for the paint industry

Calcium Carbonate (Limestone)
Removal of sulphur dioxide produced from the burning of coal in power stations
Very fine and highly pure calcium carbonate is used as filler in plastics and paper, providing bulk but not altering the properties of the substance itself
Finely crushed calcium carbonate is used in paints to create a malt finish
Used in the agricultural industry to neutralise acidic soils and attain optimal soil conditions for crop growth

Magnesium Hydroxide
Waste water treatment chemical used widely in industry for its neutralising properties
Used for pH adjustment (acid neutraliser) in high carbohydrate anaerobic digesters
Used as a feed supplement for animals/livestock
Used as pigment extender in paint and varnish
Used as a magnesium source in fertilisers
Used as insulation material
Used in the pharmaceutical industry in a variety of products including antacids, cosmetics, toothpaste and ointments.

It will be appreciated that in embodiments of the present invention where two (or more) steps are required, these steps do not necessarily need to be performed immediately after one another, at the same location, or by the same operator. For example, in some embodiments, the production and separation of a magnesium containing precipitate from the spent brine could be performed in a first plant and, assuming it was necessary, the spent brine could be processed to recover the carbonate product in a second plant. Further, in some embodiments of the present invention involving two (or more) steps, the order of the steps may be altered in some circumstances in order to optimise the overall method.

In some embodiments, the invention relates to an effective treatment system that facilitates the recovery of useful mineral products from alkaline brines to achieve ZLD. In some embodiments, the invention relates to a treatment system to achieve ZLD through recovery of one or more mineral products and a liquid caustic product.

Specific embodiments of present invention in the form of a comprehensive treatment system for (optionally) achieving ZLD through sequential or selective recovery of commercial grade solid and liquid products from alkaline brines are provided by the process steps described below and as schematically shown in the accompanying Figures.

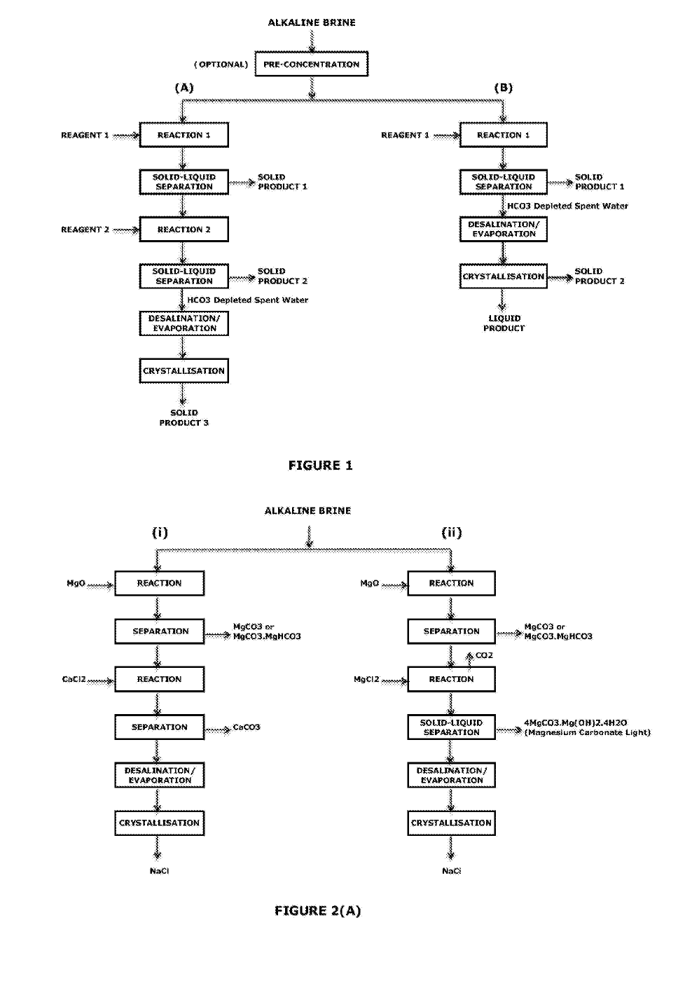

Referring firstly to FIG. 1 and according to a first embodiment of the invention (A), there is provided a method of treatment of alkaline brine (or optionally a pre-concentrated alkaline brine) for recovery of solid products and achieving ZLD, shown in FIG. 1, embodiment (A) and comprising the steps of:
(a) contacting the alkaline brine with a first reagent comprising a source of magnesium (Mg) ions selected from the group consisting of magnesia (MgO), dolime (MgO.CaO), magnesium chloride (MgCl₂), magnesium sulphate (MgSO₄), partially calcined dolomite, magnesium rich lime (CaO) and magnesium hydroxide (Mg(OH)₂) or a combination thereof, so as to cause at least some solids dissolved in the water to react with the first reagent in a solid-liquid reaction and to form a first solid product (magnesium containing precipitate) and a first partially processed water (spent brine). Optionally, contacting the alkaline brine with a magnesium (Mg) source as listed above in conjunction with a calcium source consisting of lime (CaO), calcium chloride (CaCl₂) and partially dehydrated gypsum (CaSO₄.nH₂O) or a combination thereof.
(b) recovering the first solid product from the first partially processed water,
(c) contacting the first partially processed water with a second reagent comprising a source of magnesium (Mg) ions or calcium (Ca) ions or a combination thereof, so as to cause at least some solids dissolved in the first partially processed water to react with the second reagent in a liquid-liquid reaction or solid-liquid reaction and to form a second solid product and the second partially processed water;
(d) recovering the second solid product from the second partially processed water;
(e) concentrating the second partially processed water which is depleted in bicarbonate ion using solar, membrane desalination or thermal evaporation methods or a combination thereof, so as to reduce the volume of the second partially processed water and optionally recover fresh water; and
(f) subjecting the concentrated second partially processed water to a solar or a thermo-mechanical crystallisation process so as to recover a third solid product.

Referring again to FIG. 1 and according to a second embodiment of the invention (B), there is provided a method of treatment of alkaline brine (or optionally a pre-concentrated alkaline brine) for recovery of solid and liquid products and achieving ZLD, and comprising the steps of (a) (b), (e) and (f) of the first embodiment, shown in FIG. 1(A), wherein in step (f) a stream of concentrated liquid is recovered in the solar or thermo-mechanical crystallization process for further processing and beneficial use.

As shown in FIG. 1, before treatment, the alkaline brine may optionally be pre-concentrated to achieve a higher concentration of the dissolved bicarbonate ion; by using solar, membrane or thermo-mechanical volume reduction processes. Whereas such pre-concentration will also increase the concentration of certain dissolved contaminants, the treatment system disclosed herein enables the effective removal of such contaminants by following the teachings of this invention.

Because of the use of magnesium (Mg) ion containing first reagent, the precipitates from the first reaction step may be carbonate minerals containing Mg ion, which precipitates may include one or more mineral types with discrete crystalline phase or comprised of both solid and amorphous solid substances thus providing a means for adsorption of certain dissolved elements which my otherwise potentially be transferred to subsequent process steps.

In some embodiments, alkaline brine may be contacted with predetermined amount of magnesium (Mg) ion containing reagents. The predetermined amount refers to a stoichiometric amount needed to remove part or all of the dissolved HCO₃⁻/CO₃²⁻ ions in the feed alkaline brine. The amount of reagent for each reaction step is determined prior in order to achieve complete removal of HCO₃/CO₃²⁻ ion from the processed water before subjecting it to desalination/evaporation step, as shown in FIG. 1.

The predetermined amount of the first reagent may be an amount required for minimum removal of HCO₃⁻/CO₃²⁻ ion if the primary objective is to remove certain contaminants from the brine by precipitation through combination of crystallization, flocculation, adsorption and coagulation processes. For example, in the two-step reaction treatment system shown in FIG. 1, embodiment (A), the predetermined amount of the first reagent may be sufficient to remove about 10 to 50% of the stoichiometric amount of dissolved HCO₃⁻/CO₃²⁻ ion with the balance of dissolved HCO₃⁻/CO₃²⁻ in the first partially processed water removed by predetermined amount of the second reagent. In the one-step reaction treatment system shown in FIG. 1, embodiment (B), the amount of Mg ion containing reagent will be sufficient to substantially completely remove the dissolved HCO₃⁻/CO₃²⁻ content in the feed brine.

Mineral product types and recovery rates from the treatment system of the invention will depend on a number of variables, notably reagent type, TDS salinity, brine quality in terms of Cl⁻/HCO₃⁻ molar and Cl⁻/2SO₄²⁻ molar ratios, and the reaction conditions (pH of process water, reaction temperature and duration).

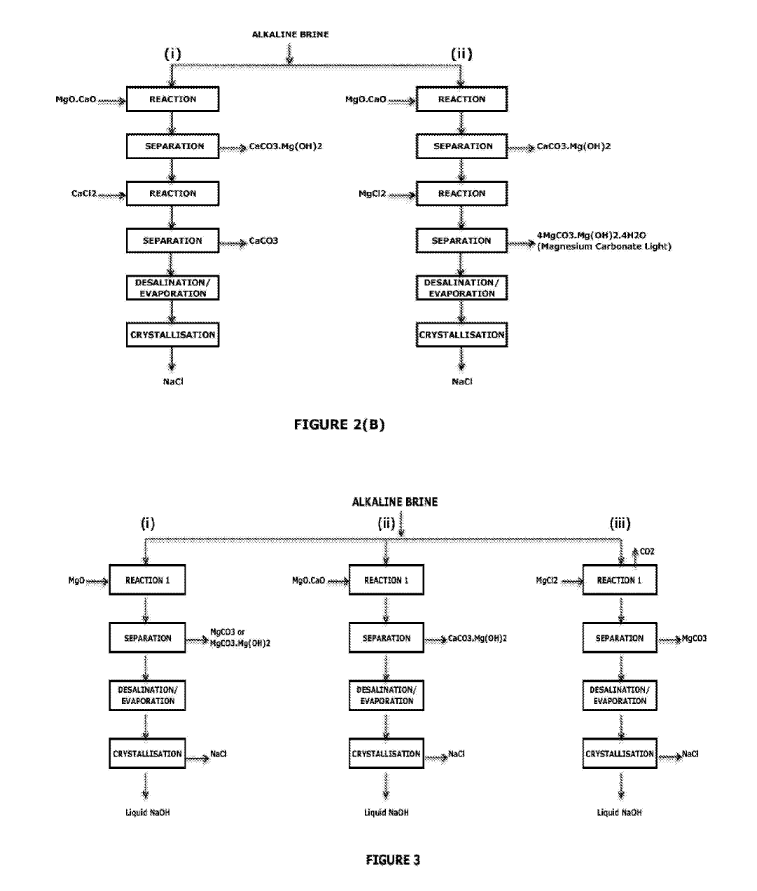

Further specific embodiments of this invention are hereunder described with reference to FIGS. 2 to 5.

In the embodiments shown in FIGS. 2(A) and 2(B), the method of the invention is operated as a ZLD process for co-producing a suite of carbonate mineral products in two reaction steps and sodium chloride salt from the HCO₃⁻/CO₃²⁻ depleted Na—Cl brine. In this embodiment, the brine is reacted, in step (a) either with a milk of hydrated magnesia (MgO) or a milk of hydrated dolime (MgO.CaO), having a predetermined solids content. This solid-liquid reaction step is followed by step (b) involving the transfer of the thin slurry formed in the reaction vessel to a thickener for solid-liquid separation. The thickened slurry is then washed in an appropriate washing unit, the magnesium-containing precipitate separated from the filtrate and optionally dried. Where required, the raw feed water (alkaline brine) or a concentrate of the same may be added to the partially processed water from step (b) at a predetermined volumetric ratio to lower the pH of the partially processed water (spent brine). This partially processed water is then reacted either with either magnesium chloride (MgCl₂) or calcium chloride (CaCl₂) liquid reagent, each having a predetermined concentration and dosing rates to achieve substantially 100% removal of dissolved HCO₃⁻/CO₃²⁻ ion from the partially processed water. The slurry thus formed from this liquid-liquid reaction step (c) is then separated from the partially processed water in step (d) using a thickener and subsequently washed in an appropriate washing unit and optionally dried. The partially processed water from step (d) is then subjected to further concentration in step (e), using an appropriate solar, membrane, thermo-mechanical or a combination thereof, and finally converted to NaCl salt in step (f) using a thermal crystalliser, or a conventional salt harvesting method or a combination thereof.

In another embodiment, shown in FIG. 3, the method of the invention is operated as a ZLD process for co-producing a carbonate mineral product, NaCl salt and a terminal liquid stream comprised of NaOH in an integrated one-step reaction treatment system. In this embodiment, the brine is first reacted either with a milk of hydrated magnesia (MgO) or a milk of hydrated dolime (MgO.CaO), each having a predetermined solids content and at a rate to achieve substantially 100% removal of dissolved HCO₃⁻/CO₃²⁻ ion by means of solid-liquid reaction in step (a). The step (a) may be optionally accomplished by reacting the alkaline brine with magnesium chloride (MgCl₂) liquid reagent, with the latter having a predetermined concentration and applied at a rate to achieve 100% removal of dissolved HCO₃⁻/CO₃²⁻ ion by means of liquid-liquid reaction. The follow up step (b) involves the transfer of the thin slurry formed in step (a) to a thickener for solid-liquid separation. The thickened slurry is then washed in an appropriate washing unit and then separated from the filtrate and optionally dried. Where required the raw feed water or a concentrate of the same may be added to the partially processed water from step (b) at a predetermined volumetric ratio to lower the pH. The processed water is then subjected to further concentration in step (c) using an appropriate solar, membrane or thermo-mechanical process or a combination thereof. Finally, in step (d) the concentrated brine is converted to NaCl salt using a thermal crystalliser wherein the caustic rich bleed from the crystalliser is separated and retained for beneficial use.

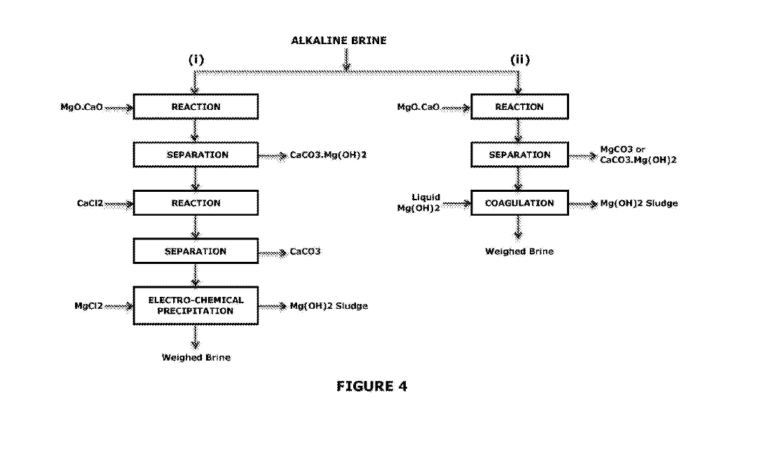

In a further embodiment of the method of the invention, as shown in FIG. 4, the spent brine from either two-step or one-step processing options (schematically shown in FIG. 2(B)(i) and FIG. 3(ii)) is further treated to reduce or eliminate the presence of certain dissolved contaminants in the partially processed brine to produce weighed brine. One purification option shown in FIG. 4(i) involves the application of electro-chemical precipitation (ECP) method, wherein a predetermined concentration of MgCl₂ solution may be added to the partially processed water, having a pH value in the range of 6-7, then subjecting the liquid to electro-coagulation for the purpose of enhancing the efficiency of contaminants removal by the combined effects of electro-coagulation, adsorption, flocculation and electro-precipitation processes. Optionally, the EC unit may use sacrificial Mg anode. Another purification option, shown in FIG. 4(ii) involves the addition of liquid Mg(OH)₂ to the partially processed water, having a pH value in excess of 9.6 characterized by elevated pH condition, then mixing the liquid in a mixing vessel for the purpose of enhancing the efficiency of contaminants removal by the combined effects of flocculation, adsorption, coagulation and precipitation processes.

The invention as disclosed herein provides an effective method for conversion of alkaline brines to a suite of solid mineral and liquid products whereby the need for disposal of such brines is minimised or eliminated. The embodiments described above with reference to FIG. 1 to 4 represent some of the many ways in which beneficial use of alkaline brines through the recovery of useful products may be realised according to process steps described above. Furthermore, the invention includes within its scope any portion of any of the above described treatment system and system components of the invention optionally combined either wholly or partially with any one or more of the other processes so as to define the most appropriate configuration for the invented treatment system for achieving a particular objective, including ZLD outcomes.

Specific examples of the method of the present invention will now be described.

### Example 1

(a) A synthetic alkaline brine sample was created to replicate a reverse osmosis brine stream from a coal seam gas (CSG) produced water treatment plant. The chemical composition of the feed brine was:

| Species | Concentration (mg/L) |
|---|---|
| Na | 13,762 |
| Cl | 5,177 |
| HCO₃ | 10,682 |
| CO₃ | 8,327 |
| pH | 9.6 |

A synthetic dolime reagent was produced by mixing 0.88 g of Magnesium Oxide and 1.23 g of Calcium Oxide. The mixture was added to 21.09 g of water and mixed for 30 minutes. The synthetic dolime solution was added to 250 mL of the synthetic alkaline brine and the resultant solution was reacted whilst being stirred for 60 minutes. Following the reaction period the solution was allowed to settle and 176.5 mL of supernatant was removed for the second reaction step.

5.34 g of calcium chloride dihydrate was added to 10.67 g of water and was mixed until dissolved. The calcium chloride solution was added to the supernatant recovered after the first reaction step. The solution was reacted for 60 minutes with stirring. Following the reaction period the solution was allowed to settle. The resultant supernatant solution was analysed for remaining alkalinity (i.e. proportion of HCO₃⁻/CO₃²⁻ ions remaining) after step 1 and step 2. The results are summarised in the table 2 below.

(b) A synthetic alkaline brine sample was created to replicate a reverse osmosis brine stream from a coal seam gas (CSG) produced water treatment plant. The chemical composition of the feed brine was:

| Species | Concentration (mg/L) |
|---|---|
| Na | 13,762 |
| Cl | 5,177 |
| HCO₃ | 10,682 |
| CO₃ | 8,327 |
| pH | 9.6 |

A synthetic dolime reagent was produced by mixing 0.88 g of Magnesium Oxide and 1.23 g of Calcium Oxide. The mixture was added to 21.08 g of water and mixed for 30 minutes. The synthetic dolime solution was added to 250 mL of the synthetic alkaline brine and the resultant solution was reacted whilst being stirred for 60 minutes. Following the reaction period the solution was allowed to settle and 138.8 mL of supernatant was removed for the second reaction step.

5.82 g of magnesium chloride hexahydrate was added to 11.63 g of water and was mixed until dissolved. The magnesium chloride solution was added to the supernatant recovered after the first reaction step. The solution was reacted for 60 minutes with stirring. Following the reaction period the solution was allowed to settle. The resultant supernatant solution was analysed for remaining alkalinity after step 1 and step 2. The results are summarised in the table below.

TABLE 2

| | | % Alkalinity |
|---|---|---|
| | % Alkalinity Conversion | conversion |
| Trial | after the first step | after the second step |
| (a) CSG + MgO•CaO + | 27.1 | 95.8 |
| CaCl2•2H2O | | |
| (b) CSG + MgO•CaO + | 30.7 | 92.0 |
| MgCl2•6H2O | | |

The results shown in table 2 demonstrate good removal of carbonate and bicarbonate from the feed alkaline brine (step 1) and spent brine (step 2). Slightly higher removal of carbonate and bicarbonate was observed when calcium chloride was used in the second step instead of magnesium chloride, as expected from solubility products of calcium carbonate as opposed to magnesium carbonate.

### Example 2

A synthetic alkaline brine sample was created to replicate a brine concentrator (BC) brine stream from a coal seam gas (CSG) produced water treatment plant. The chemical composition of the feed brine was:

| Species | Concentration (mg/L) |
|---|---|
| Na | 91,590 |
| Cl | 107,440 |
| HCO₃ | 5,000 |
| CO₃ | 25,260 |
| Si | 550 |
| pH | 10 |

Various reagents were added as a dry powder to 200 mL samples of the synthetic BC brine and reacted for 60 minutes. For the first 15 minutes of the reaction vigorous stirring was utilised, while slower stirring was utilised for the remaining 45 minutes. Where two reagents are noted as being used, the reagents were added at the same time. Following the reaction period, the solution was filtered and the silicon concentration was measured in each of the filtrates to determine silica removal efficiency. The dose rates and removal efficiencies are provided in the below table 3.

TABLE 3

| | | | | Silica |
|---|---|---|---|---|
| | | | | Removal |
| | Reagent 1 | | Reagent 2 | Efficiency |
| Reagent 1 | Amount (g) | Reagent 2 | Amount (g) | (%) |
| CaO | 2.82 | MgCl₂•6H₂O | 10.22 | 97.8 |
| MgO•CaO | 4.85 | MgCl₂•6H₂O | 10.22 | 97.6 |
| MgO | 4.05 | — | — | 97.5 |
| MgO | 2.03 | CaCl₂•2H₂O | 7.40 | 97.3 |
| MgO | 2.03 | CaSO₄•½H₂O | 7.31 | 97.1 |
| MgO | 2.03 | MgCl₂•6H₂O | 10.2 | 96.4 |
| CaO | 5.65 | — | — | 58.2 |
| CaO | 2.19 | CaCl₂•2H₂O | 5.73 | 54.5 |

The removal efficiencies achieved (see table 3) highlight the enhanced contaminant (i.e. silica) removal achieved when magnesium containing reagents are added under conditions favouring the formation of a magnesium hydroxide precipitate compared to that when only calcium containing reagents are used.

### Example 3

A sample of CSG reverse osmosis brine was obtained from an external source. The brine had the following composition and separate samples of the brine were subjected to the treatment steps listed in processes (a) to (f):

| Species | Concentration (mg/L) |
|---|---|
| Na | 14,000 |
| Ca | 25 |
| Mg | 8 |
| SO₄ | 49 |
| Cl | 7,900 |
| HCO₃ | 17,000 |
| CO₃ | 3,300 |
| Si | 66 |
| pH | 9.3 |

(a) 6.47 g of Magnesium Oxide and 9.00 g of Calcium Oxide were added to a beaker containing 139.35 g of water. This synthetic dolime solution was mixed for 180 minutes to allow the oxides to hydrate. 500 mL of the brine solution was added to the reagent solution and the solution was reacted with stirring for 180 minutes. After the reaction period the solid was recovered via filtration and the supernatant was analysed for residual carbonate and bicarbonate ions.

(b) 32.643 g of Magnesium Chloride hexahydrate was added to a beaker containing 293.63 g of water. This magnesium chloride solution was mixed until all of the magnesium chloride had dissolved. 500 mL of the brine solution was added to the reagent solution and the solution was reacted with stirring for 180 minutes. After the reaction period the solid was recovered via filtration and the supernatant was analysed for residual carbonate and bicarbonate ions.

(c) 6.215 g of calcined dolomite was added to a beaker containing 55.933 g of water. This dolime solution was mixed for 180 minutes. 500 mL of the brine solution was added to the reagent solution and the solution was reacted with stirring for 90 minutes. After the reaction period the solid was recovered via filtration and the supernatant was collected and analysed for residual carbonate and bicarbonate ions.

7.13 g of calcium chloride dihydrate was mixed with 64.21 g of water. The calcium chloride solution was mixed until the solid was dissolved. The calcium chloride solution was added to 250 mL of the supernatant recovered from the first step reaction (in (c)) and the solution was reacted with stirring for 90 minutes. After the reaction period the solid was recovered via filtration and the supernatant was analysed for residual carbonate and bicarbonate ions.

(d) 2.61 g of magnesium oxide was added to a beaker containing 23.43 g of water. This magnesium oxide solution was mixed for 180 minutes. 500 mL of the brine solution was added to the reagent solution and the solution was reacted with stirring for 120 minutes. After the reaction period the solid was recovered via filtration and the supernatant was collected and analysed for residual carbonate and bicarbonate ions.

10.60 g of magnesium chloride hexahydrate was mixed with 95.38 g of water. The magnesium chloride solution was mixed until the solid was dissolved. The magnesium chloride solution was added to 250 mL of the supernatant recovered from the first step reaction (in (d)) and the solution was reacted with stirring for 90 minutes. After the reaction period the solid was recovered via filtration and the supernatant was analysed for residual carbonate and bicarbonate ions.

(e) 2.61 g of magnesium oxide was added to a beaker containing 23.51 g of water. This magnesium oxide solution was mixed for 210 minutes. 500 mL of the brine solution was added to the reagent solution and the solution was reacted with stirring for 90 minutes. After the reaction period the solid was recovered via filtration and the supernatant was collected and analysed for residual carbonate and bicarbonate ions.

7.55 g of calcium chloride dihydrate was mixed with 68.08 g of water. The calcium chloride solution was mixed until the solid was dissolved. The calcium chloride solution was added to 250 mL of the supernatant recovered from the first step reaction (in (c)) and the solution was reacted with stirring for 90 minutes. After the reaction period the solid was recovered via filtration and the supernatant was analysed for residual carbonate and bicarbonate ions.

(f) 2.60 g of magnesium oxide was added to a beaker containing 23.66 g of water. This magnesium oxide solution was mixed for 240 minutes. 500 mL of the brine solution was added to the reagent solution and the solution was reacted with stirring for 90 minutes. After the reaction period the solid was recovered via filtration and the supernatant was collected and analysed for residual carbonate and bicarbonate ions.

9.87 g of bassanite was mixed with 88.74 g of water. The bassanite solution was mixed for 25 minutes. The bassanite solution was added to 250 mL of the supernatant recovered from the first step reaction (in (f)) and the solution was reacted with stirring for 120 minutes. After the reaction period the solid was recovered via filtration and the supernatant was analysed for residual carbonate and bicarbonate ions.

Refer to the below table 4 for the results of the alkalinity conversion through the various reaction paths described above.

TABLE 4

| | | | CO₃ + HCO₃ | CO₃ + HCO₃ |
|---|---|---|---|---|
| | | | Conversion | Conversion |
| Trial | Reagent Step 1 | Reagent Step 2 | After Step 1 | After Step 2 |
| (a) | MgO + CaO | — | 68.9% | — |
| (b) | MgCl₂•6H₂O | — | 91.9% | — |
| (c) | MgO•CaO | CaCl₂•2H₂O | 20.7% | 88.3% |
| (d) | MgO | MgCl₂•6H₂O | 25.3% | 86.0% |
| (e) | MgO | CaCl₂•2H₂O | 29.4% | 99.4% |
| (f) | MgO | CaSO₄•0.5H₂O | 15.8% | 98.8% |

The results shown in table 4 (above) demonstrate good removal of carbonate and bicarbonate from the feed alkaline brine via different reagent combinations. A range of beneficial products were obtained including hydromagnesite, magnesium carbonate and calcium carbonate, depending on the reagents selected.

### Example 4

A sample of CSG reverse osmosis (RO) brine was obtained from an external source. The brine had the following composition:

| Species | Concentration (mg/L) |
|---|---|
| Na | 14,000 |
| Ca | 25 |
| Mg | 8 |
| SO₄ | 49 |
| Cl | 7,900 |
| HCO₃ | 15,738 |
| CO₃ | 3,789 |
| Si | 66 |
| pH | 9.3 |

A sample of real CSG brine concentrator (BC) brine was obtained from an external source. The brine had a pH of 10 and the following composition:

| Species | Concentration (mg/L) |
|---|---|
| Na | 44,000 |
| Ca | 15 |
| Mg | 5 |
| SO₄ | 160 |
| Cl | 21,000 |
| HCO₃ | 11,786 |
| CO₃ | 38,207 |
| Si | 200 |

(a) 3.88 g of Magnesium Oxide and 5.40 g of Calcium Oxide were added to a beaker containing 83.57 g of water. This synthetic dolime solution was mixed for 180 minutes to allow the oxides to hydrate. 1,000 mL of the RO brine solution was added to the reagent solution and the solution was reacted with stirring for 180 minutes. After the reaction period, 15.75 g of solid was recovered via filtration and the supernatant was analysed for residual carbonate and bicarbonate ions and silicon content.

20.94 g of magnesium chloride hexahydrate was mixed with 188.54 g of water. The magnesium chloride solution was mixed until the solid was dissolved. The magnesium chloride solution was added to 500 mL of the supernatant recovered from the first step reaction (in (a)) and the solution was reacted with stirring for 180 minutes. After the reaction period 10.05 g of solid was recovered via filtration and the supernatant was analysed for residual carbonate and bicarbonate ions and silicon content.

(b) 3.88 g of Magnesium Oxide and 5.40 g of Calcium Oxide were added to a beaker containing 1,000 mL of the RO brine solution and reacted with stirring for 180 minutes. After the reaction period 38.43 g of solid was recovered via filtration and the supernatant was analysed for residual carbonate and bicarbonate ions and silicon content.

20.40 g of magnesium chloride hexahydrate was added to 500 mL of the supernatant recovered from the first step reaction (in (b)) and the solution was reacted with stirring for 180 minutes. After the reaction period 11.11 g of solid was recovered via filtration and the supernatant was analysed for residual carbonate and bicarbonate ions and silicon content.

(c) 10.03 g of Magnesium Oxide and 13.96 g of Calcium Oxide were added to a beaker containing 215.98 g of water. This synthetic dolime solution was mixed for 180 minutes to allow the oxides to hydrate. 1,000 mL of the BC brine solution was added to the reagent solution and the solution was reacted with stirring for 180 minutes. After the reaction period 78.62 g of solid was recovered via filtration and the supernatant was analysed for residual carbonate and bicarbonate ions and silicon content.

40.05 g of calcium chloride dihydrate was mixed with 360.75 g of water. The calcium chloride solution was mixed until the solid was dissolved. The calcium chloride solution was added to 500 mL of the supernatant recovered from the first step reaction (in (c)) and the solution was reacted with stirring for 180 minutes. After the reaction period 27.24 g of solid was recovered via filtration and the supernatant was analysed for residual carbonate and bicarbonate ions and silicon content.

Refer to the below table 5 for the results of the alkalinity conversion and silicon removal through the various reaction paths described above.

TABLE 5

| | | | | Alkalinity Conversion | | Silicon Removal | |
|---|---|---|---|---|---|---|---|
| | | Reagents | | After | | After | |
| Trial | Brine Source | Step 1 | Step 2 | Step 1 | Step 2 | Step 1 | Step 2 |
| (a) | RU | MgO + | MgCl₂•6H₂O | 30.5% | 76.6% | 26.5% | 26.5% |
| | | CaO | | | | | |
| (b) | RO | MgO + | MgCl₂•6H₂O | 37.5% | 88.0% | 31.4% | 42.7% |
| | | CaO | | | | | |
| (c) | BC | MgO + | CaCl₂•2H₂O | 20.2% | 85.0% | 87.8% | 87.8% |
| | | CaO | | | | | |

The results shown in table 5 (above) demonstrate good carbonate and bicarbonate removal from both RO and BC alkaline brines. High silicon removal was recorded via the reaction between dolime and BC brine, which demonstrates good silica removal (note that silicon content was measured in order to encompass all forms of silicon and not just reactive silica). Reasonably good silicon removal was demonstrated in the reaction paths performed on the RO brine, with dry addition of the reagents (i.e. trial (b)) producing improved alkalinity and silica removal efficiencies.

### Example 5

A sample of CSG brine concentrator (BC) brine was obtained from an external source. The brine had the following composition:

| Species | Concentration (mg/L) |
|---|---|
| Na | 44,000 |
| Ca | 15 |
| Mg | 5 |
| SO₄ | 160 |
| Cl | 21,000 |
| HCO₃ | 11,786 |
| CO₃ | 38,207 |
| Si | 200 |

A two-step reaction treatment process using dolime and calcium chloride in the first and second reaction steps, respectively, was carried out and halide contaminant removal was assessed through the reaction path. Refer to Example 4(c) for the experimental procedure.

Table 6 shows the halide (fluoride, bromide and iodide) concentration in the original BC brine and after the first and second reaction steps.

TABLE 6

| | | After first | After second step |
|---|---|---|---|
| | | reaction step | reaction (100% |
| Parameter | BC Brine Feed | (30% dolime) | calcium chloride) |
| Fluoride (mg/L) | 140 | 25 | 5.6 |
| Bromine | 60 | 52 | 25 |
| (mg/L) | | | |
| Iodine (mg/L) | 0.12 | 0.12 | 5.5 |

The results show significant halide removal after the first reaction step, with a further reduction seen after the second reaction, bar the iodine concentration, which increased slightly. This increase in iodine however, was only the result of iodine introduced into the brine via the second step reagent.

As will be appreciated, specific embodiments of the present invention may provide one or more of the following advantages:
the method can be tailored such that a minimum number of steps can be used to obtain a maximum amount of beneficial products, but whilst still treating the alkaline brine;
embodiments of the present invention can be tailored to target specific contaminants within the alkaline brine stream, and to recover the most valuable by-products possible;
alkaline brine can be fully treated without necessarily requiring the use of techniques requiring specialised equipment (e.g. reverse osmosis) or specialised reagents (e.g. flocculants, water conditioning or softening reagents);
a number of reagents and combinations of reagents can potentially be used, thereby providing the user with a degree of flexibility to choose the most economical reagents for use based on the current market conditions;
similarly, it may be possible to influence what beneficial product(s) are produced, in order to maximise profit based on the current market conditions;
many of the reagents which can be utilised are readily available and relatively cheap;
treatment costs can be offset through the production of beneficial products;
the method may result in ZLD;
the method may result in a weighed brine; and
the amount of contaminated solids requiring disposal may be significantly reduced, compared with prior art processes.

It will be understood to persons skilled in the art of the invention that many modifications may be made to the specific methods described above without departing from the spirit and scope of the invention, as defined in the following claims.

In the claims which follow and in the preceding description of the invention, except where the context requires otherwise due to express language or necessary implication, the word “comprise” or variations such as “comprises” or “comprising” is used in an inclusive sense, i.e. to specify the presence of the stated features but not to preclude the presence or addition of further features in various embodiments of the invention.

1. A method for treating an alkaline brine, whereby a resultant treated alkaline brine has a reduced amount of carbonate or bicarbonate ions, the method comprising:
adding a source of magnesium ions to the alkaline brine;
separating a resultant magnesium-containing precipitate to produce a spent brine; and, if the spent brine contains a sufficient amount of carbonate or bicarbonate ions:
processing the spent brine to recover a carbonate product.

2. The method of claim 1, wherein reactions between the source of magnesium ions and the alkaline brine are controlled to favour the formation of a precipitate comprising mainly magnesium carbonate (MgCO3).

3. The method of claim 1, wherein reactions between the source of magnesium ions and the alkaline brine are controlled to favour the formation of a precipitate comprising mainly magnesium hydroxide (Mg(OH)₂).

4. The method of claim 1, wherein a composition of the magnesium-containing precipitate is controllable by controlling a pH at which the source of magnesium ions are added to the alkaline brine.

5. The method of claim 1, wherein a composition of the magnesium-containing precipitate is controllable by selecting the source of magnesium ions added to the alkaline brine.

6. (canceled)

7. The method of claim 1, wherein the source of magnesium ions is added to the alkaline brine in combination with another reagent.

8. The method of claim 7, wherein the other reagent is a source of calcium ions.

9. (canceled)

10. The method of claim 1, wherein processing the spent brine to recover a carbonate product comprises:
adding a source of a divalent cation to the spent brine, whereupon the carbonate product is precipitated in the fonn of a carbonate product containing the divalent cation.

11. The method of claim 10, wherein the amount of the source of a divalent cation added to the spent brine is the amount required to cause precipitation of substantially all of the carbonate ions in the spent brine.

12. The method of claim 10, wherein the source of a divalent cation is a chloride salt.

13. The method of claim 10, wherein the source of a divalent cation is an alkaline earth chloride salt.

14. (canceled)

15. The method of claim 10, further comprising reducing a pH of the spent brine before adding the source of a divalent cation.

16. The method of claim 15, wherein the pH of the spent brine is reduced by adding some of the alkaline brine to the spent brine.

17. The method of claim 10, further comprising reducing a volume of the spent brine before adding the source of a divalent cation.

18. The method of claim 10, further comprising separating the carbonate product containing the divalent cation to produce a second spent brine.

19. The method of claim 18, wherein the second spent brine is processed to produce sodium chloride.

20. The method of claim 1, wherein processing the spent brine to recover a carbonate product comprises:
evaporating the spent brine.

21. The method of claim 1, wherein determining whether the spent brine contains a sufficient amount of carbonate or bicarbonate ions comprises measuring an amount of carbonate or bicarbonate ions in the alkaline brine and calculating a proportion of the carbonate or bicarbonate ions contained in the magnesium-containing precipitate.

22. The method of claim 1, wherein determining whether the spent brine contains a sufficient amount of carbonate or bicarbonate ions comprises measuring the amount of carbonate or bicarbonate ions in the spent brine.

23. The method of claim 1, wherein the alkaline brine is pre-concentrated before the source of magnesium ions is added.
